(19) United States
(12) Patent Application Publication
(10) Pub. No.: US 2025/0109822 A1
(43) Pub. Date: Apr. 3, 2025

(54) COLLAPSIBLE BAG AND/OR TRAY SUPPORTING APPARATUS

(71) Applicant: Seasucker, LLC, Bradenton, FL (US)

(72) Inventor: Milton L Pinto, Sarasota, FL (US)

(21) Appl. No.: 18/479,563

(22) Filed: Oct. 2, 2023

(51) Int. Cl. F16M 13/02; A47B 96/07; B65D 33/00; B65D 33/14; B65D 33/16

(52) U.S. Cl. CPC F16M 13/02; A47B 96/07; B65D 33/007; B65D 33/14; B65D 33/1616; F16M 2200/063

(57) ABSTRACT

A collapsible holding device supporting apparatus is releasably mountable to a separate surface and includes first and second proximal arms, first and second distal arms and a handle that are interconnected by pivot connections. A holding device is supported on the first and second proximal arms and the first and second distal arms with the holding device surrounded by the arms. The pivot connections enable the handle to be moved toward the separate surface causing the first and second proximal arms and the first and second distal arms to move to adjacent, side by side positions and closing the holding device, and enable the handle to be moved away from the separate surface causing the first and second proximal arms and first and second distal arms to be move to angled orientations and opening the holding device surrounded by the arms.

### BACKGROUND

It is often desirable to have a trash bag nearby to keep an area occupied by a person free of trash and litter. For example, it is often desirable to have a trash bag available in a vehicle such as an automobile or a boat so that an occupant of the automobile or boat can dispose of trash in the trash bag and thereby avoid trash cluttering the interior of the automobile or boat. However, in use the trash bag, being unsecured to the vehicle interior may end up cluttering the interior of the automobile or boat.

It is also often desirable to have a stationary surface available in an area occupied by a person for the convenience of the person to put an object on the surface when the object is not being held by the person. For example, it is often desirable to have a tray available in a vehicle such as an automobile or a boat so that an occupant of the automobile or boat would have a surface to put an object on such as a food item when the food item is not being held by the occupant. However, vehicles such as automobiles or boats are not provided with food trays.

### SUMMARY

This disclosure is directed to a collapsible holding device supporting apparatus, for example a collapsible bag and/or tray supporting apparatus that meets the above-described needs. This disclosure is directed to the structure and functioning of the collapsible bag and/or tray supporting apparatus.

In particular, this disclosure pertains to the construction and functioning of a trash bag suspending apparatus that is releasably attachable to a separate surface, and is movable between a collapsed position where a trash bag suspended by the apparatus is stowed and positioned adjacent the surface in an unobtrusive manner, and an expanded position where the apparatus opens a top opening of a trash bag and suspends the trash bag outwardly from the surface for use.

Additionally, this disclosure pertains to the construction and functioning of a food tray supporting apparatus that is releasably attachable to a separate surface, and is movable between a collapsed position where a tray supported by the apparatus is stowed and positioned adjacent the surface in an unobtrusive manner, and an expanded position where the apparatus opens the food tray and supports the food tray extending outward from the surface for use.

A collapsible bag suspending apparatus is designed for holding a bag in a convenient location adjacent a separate surface. The apparatus suspends the bag, for example a trash bag in a stowed, unobtrusive configuration adjacent the surface when not in use, and in an opened configuration adjacent the surface when in use.

The apparatus includes a mount that is releasably attachable to a separate surface to suspend the trash bag from the surface. First and second proximal arms are connected to the mount and first and second distal arms are connected to the respective first and second proximal arms. The first and second proximal arms and first and second distal arms surround an opening of the bag suspended by the arms and thereby suspend the bag from the separate surface.

The first proximal arm is connected to the mount by a pivot connection connecting a first end of the first proximal arm to the mount. The second proximal arm is also connected to the mount by a pivot connection connecting a first end of the second proximal arm to the mount.

A first end of the first distal arm is connected to a second end of the first proximal arm by a pivot connection.

A first end of the second distal arm is connected to a second end of the second proximal arm by a pivot connection.

A handle is connected by pivot connections to a second end of the first distal arm and to a second end of the second distal arm. The pivot connections enable the handle to be moved toward and into engagement with the mount, and to be moved out of engagement with and away from the mount.

As stated above, the bag of the apparatus is suspended between the first and second proximal arms and the first and second distal arms with the opening into the bag surrounded by the first and second proximal arms and the first and second distal arms. The opening into the bag is closed in response to the handle being moved toward the mount. The opening into the bag is opened in response to the handle being moved away from the mount.

The handle is movable toward and into engagement with the mount to attach the handle to the mount and thereby close the opening into the bag, and the handle is movable out of engagement with and away from the mount to thereby open the opening into the bag. With the bag closed the apparatus is collapsed to an unobtrusive position adjacent to the separate surface. When the bag is opened the apparatus is moved away from the collapsed configuration and the top opening of the bag is suspended outward from the separate surface providing easy access to the top opening of the bag.

The collapsible tray supporting apparatus is constructed in a similar manner to the collapsible bag suspending apparatus. The collapsible tray supporting apparatus is designed for supporting a tray in a convenient location adjacent to a separate surface. The apparatus supports the tray, for example a food tray in a stowed, unobtrusive configuration adjacent the surface when not in use, and in an open configuration extending outward from the surface when in use.

This embodiment of the apparatus also includes a mount that is releasably attachable to a separate surface to support the food tray from the surface. First and second proximal arms are connected to the mount and first and second distal arms are connected to the respective first and second proximal arms. The first and second proximal arms and the first and second distal arms surround a top surface of the food tray supported by the arms and thereby support the food tray from the separate surface.

The first proximal arm is connected to the mount by a pivot connection connecting a first end of the first proximal arm to the mount. The second proximal arm is connected to the mount by a pivot connection connecting a first end of the second proximal arm to the mount.

A first end of the first distal arm is connected to a second end of the first proximal arm by a pivot connection.

A first end of the second distal arm is connected to a second end of the second proximal arm by a pivot connection.

A handle is connected by pivot connections to a second end of the first distal arm and to a second end of the second distal arm. The pivot connections enable the handle to be moved toward and into engagement with the mount, and to be moved out of engagement with and away from the mount.

As stated above, the food tray of the apparatus is supported between the first and second proximal arms and the first and second distal arms with the top surface of the tray surrounded by the first and second proximal arms and the first and second distal arms. The top surface of the tray is closed in response to the handle being moved toward the mount. The top surface of the tray is opened in response to the handle being moved away from the mount.

The handle is movable toward and into engagement with the mount to attach the handle to the mount and thereby close the top surface of the tray, and the handle is moved movable out of engagement with and away from the mount to thereby open the top surface of the tray. With the top surface of the tray closed the apparatus is collapsed to an unobtrusive position adjacent the separate surface. When the top surface of the tray is opened the apparatus is moved away from the collapsed configuration and the top surface of the tray extends outward from the separate surface providing easy access to the top surface of the tray.

Further objects and features of the collapsible bag and/or tray supporting apparatus of this disclosure are set forth in the following detailed description of the apparatus and in the drawing figures.

### DESCRIPTION OF THE DRAWINGS

FIG. 1 is a representation of a perspective view of the component parts of the collapsible bag supporting apparatus prior to their assembly.

FIG. 2 is a representation of a perspective view of the assembly of the component parts of the collapsible bag supporting apparatus.

FIG. 3 is a representation of a perspective view of the further assembly of the component parts of the collapsible bag supporting apparatus.

FIG. 4 is a representation of a perspective view of the collapsible bag supporting apparatus in the opened orientation of the apparatus.

FIG. 5 is a representation of a perspective view of the collapsible bag supporting apparatus in the generally closed and collapsed orientation of the apparatus.

FIG. 6 Is a representation of a perspective view of a further embodiment of the collapsible bag supporting apparatus that is used with a separate plastic bag.

FIG. 7 Is a representation of a perspective view of the attachment of a bag to the apparatus of FIG. 6.

FIG. 8 is a representation of an expanded, perspective view of the component parts of the collapsible food tray supporting embodiment of the apparatus.

FIG. 9 is a representation of a perspective view of the food tray apparatus in the opened orientation of the apparatus.

FIG. 10 is a representation of a perspective view of the food tray apparatus in the generally closed orientation of the apparatus. Open

### DETAILED DESCRIPTION

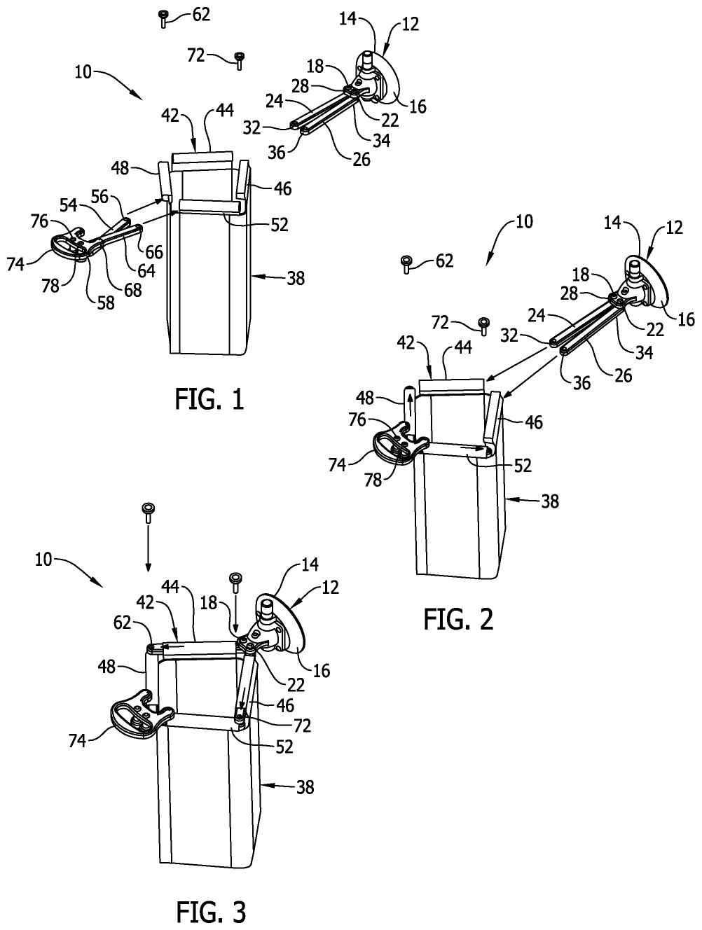

FIGS. 1-3 are representations of perspective views of the component parts and the steps involved in assembling together the component parts of the collapsible bag suspending apparatus 10 of this disclosure. The component parts of the apparatus 10 to be described are constructed of materials that provide the apparatus with sufficient structural strength to function in the manner intended. The materials used in the construction of the apparatus 10 could include metals, plastic, composites, fabrics or other equivalent types of materials.

The apparatus 10 includes a mount 12 that is constructed to be releasably attachable to a separate surface, for example a surface in the interior of a vehicle. The mount 12 has opposite first 14 and second 16 surfaces. The first surface 14 of the mount is configured as an attachment device that is releasably attachable to a separate surface, for example a vacuum suction actuator. Other equivalent types of releasable attachment devices could be employed on the mount 12.

First 18 and second 22 pivot connections are provided on the second surface 16 of the mount 12. The pivot connections 18, 22 represented in FIGS. 1-3 are pivot pins that are inserted into mating holes on the second surface 16 of the mount 12. Other equivalent types of pivot connections could be used.

A first proximal arm 24 and a second proximal arm 26 are connected to the second surface 16 of the mount 12 by the respective pivot connections 18, 22. The first proximal arm 24 has a straight, rigid length between a first end 28 of the first proximal arm and a second end 32 of the first proximal arm. The first end 28 of the first proximal arm 24 is connected by the pivot connection 18 to the second surface 16 of the mount 12. The second proximal arm 26 also has a straight, rigid length between a first end 34 of the second proximal arm and a second end 36 of the second proximal arm. The first end 34 of the second proximal arm 26 is connected by the pivot connection 22 to the second surface 16 of the mount 12.

A bag 38, for example a trash bag is suspended from the first proximal arm 24 and the second proximal arm 26. The bag 38 has a top opening 42 into the bag. The top opening 42 is surrounded by four tubular sleeves 44, 46, 48, 52. The first proximal arm 24 extends through a first of the sleeves 44 and the second proximal arm 26 extends through a second of the sleeves 46.

A first distal arm 54 extends through a third of the sleeves 48 and is connected to the first proximal arm 24. The first distal arm 54 has a rigid, straight length with opposite first 56 and second 58 ends. The first end 56 of the first distal arm 54 is connected to the second end 32 of the first proximal arm 24 by a pivot connection 62. The pivot connection 62 is provided by a pivot pin that extends through aligned pivot holes in the second end 32 of the first proximal arm 24 and the first end 56 of the first distal arm 54.

A second distal arm 64 extends through a fourth of the sleeves 52 and is connected to the second proximal arm 26. The second distal arm 64 has a rigid, straight length with opposite first 66 and second 68 ends. The first end 66 of the second distal arm 64 is connected to the second end 36 of the second proximal arm 26 by a pivot connection 72. The pivot connection 72 is provided by a pivot pin that extends through aligned pivot holes in the second end 36 of the second proximal arm 26 and the first end 66 of the second distal arm 64.

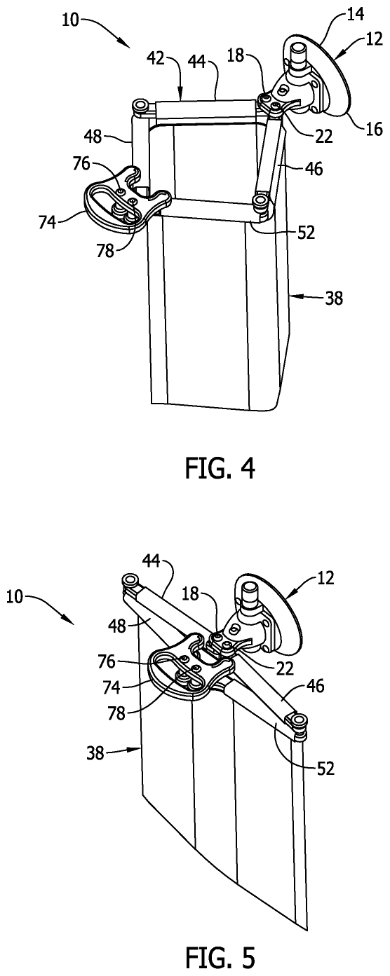

The handle 74 is connected by pivot connections 76, 78 to the second end 58 of the first distal arm 54 and to the second end 68 of the second distal arm 64. The pivot connections 76, 78 are again provided by pivot pins that are inserted through aligned pivot holes in the handle 74 and in the second end 58 of the first distal arm 54 and the second end 68 of the second distal arm 64. The pivot connections enable the handle 74 to be moved toward and into engagement with the mount 12 moving the first 24 and second 26 proximal arms into end-to-end alignment extending away from each other as represented in FIG. 5 to generally close the top opening 42 of the bag 38, and enable the handle 74 to be moved out of engagement with the mount 12 and away from the mount moving the first 24 and second 26 proximal arms to angle oriented positions extending outward from the mount to open the top opening 42 of the bag 38 as represented in FIG. 4.

As represented in FIG. 4, the bag 38 is suspended between the first 24 and second 26 proximal arms and the first 54 and second 64 distal arms with the top opening 42 of the bag 38 surrounded by the first 24 and second 26 proximal arms at angled positions relative to the first 54 and second 64 distal arms. As represented in FIG. 5, the opening 42 into the bag 38 is generally closed in response to the handle 74 being moved toward the mount 12 and into engagement with the mount.

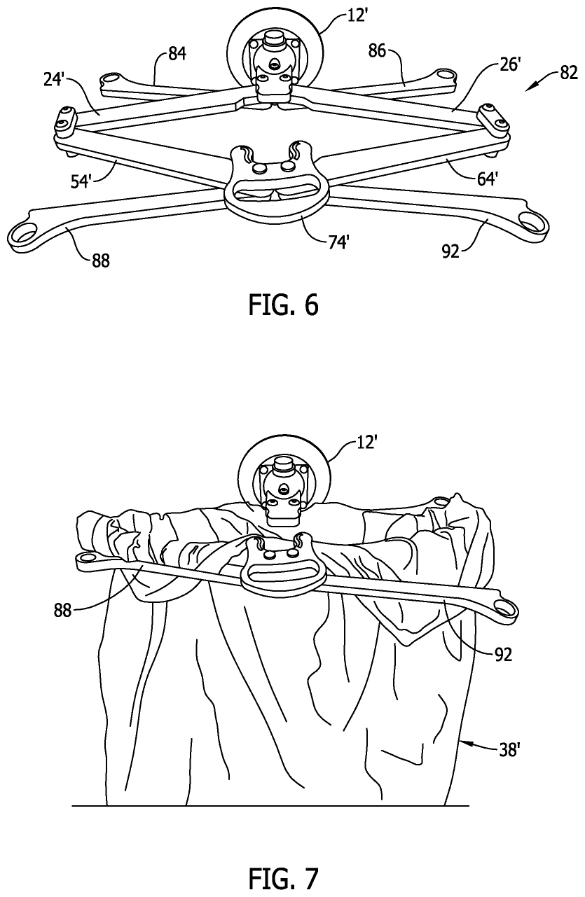

FIGS. 6 and 7 represent a further embodiment of the apparatus 82. In FIGS. 6 and 7, the apparatus 82 is also comprised of a mount 12′, first 24′ and second 26′ proximal arms, first 54′ and second 64′ distal arms and a handle 74′. These component parts of the apparatus 82 function in the same manner as the previously described embodiment of the apparatus 10.

In the apparatus 82 of FIGS. 6 and 7, there is a first bar 84 connected to the mount 12′ adjacent the first proximal arm 24′ and a second bar 86 connected to the mount 12′ adjacent the second proximal arm 26′. There is also a third bar 88 connected to the handle 74′ adjacent the first distal arm 54′ and a fourth bar 92 connected to the handle 74′ adjacent the second distal arm 64′. The first bar 84, the second bar 86, the third bar 88 and the fourth bar 92 are each separately movable in pivoting movements relative to the first proximal arm 24′, the second proximal arm 26′, the first distal arm 54′ and the second distal arm 64′, respectively.

With the first proximal arm 24′ and second proximal arm 26′, the first distal arm 54′ and second distal arm 64′, and the first bar 84, second bar 86, third bar 88 and fourth bar 92 in their relative positions represented in FIG. 6, the upper portion of the bag 38′ is extended upward between the first 24′ and second 26′ proximal arms and the first 54′ and second 64′ distal arms. As represented in FIG. 7, the upper portion of the bag 38′ is then extended over the first 24′ and second 26′ proximal arms and the first 54′ and second 64′ distal arms. The upper portion of the bag 38′ is then folded downward outside the first 24′ and second 26′ proximal arms and the first 54′ and second 64′ distal arms. The first 84 and second 86 bars are then moved to positions beneath the respective first 24′ and second 26′ proximal arms securing the upper portion of the bag 38′ between the first 84 and second 86 bars and the respective first 24′ and second 26′ proximal arms. The third 88 and fourth 92 bars are also moved to positions beneath the respective first 54′ and second 64′ distal arms securing the upper portion of the bag 38′ between the third 88 and fourth 92 bars and the respective first 54′ and second 64′ distal arms.

In each of the above embodiments of the apparatus 10, 82, the handle 74, 74′ is movable toward and into engagement with the mount 12, 12′ to attach the handle to the mount and thereby hold the opening 42, 42′ of the bag 38, 38′ closed. The handle 74, 74′ is also movable out of engagement with and away from the mount 12, 12′ to thereby open the opening 42, 42′ into the bag 38, 38′. With the bag 38, 38′ closed the apparatus 10, 82 is collapsed to an unobtrusive position adjacent to the separate surface to which the apparatus is attached. With the apparatus 10, 82 moved away from the collapsed configuration the top opening 42, 42′ of the bag 38, 38′ is opened for use providing easy access to the top opening of the bag.

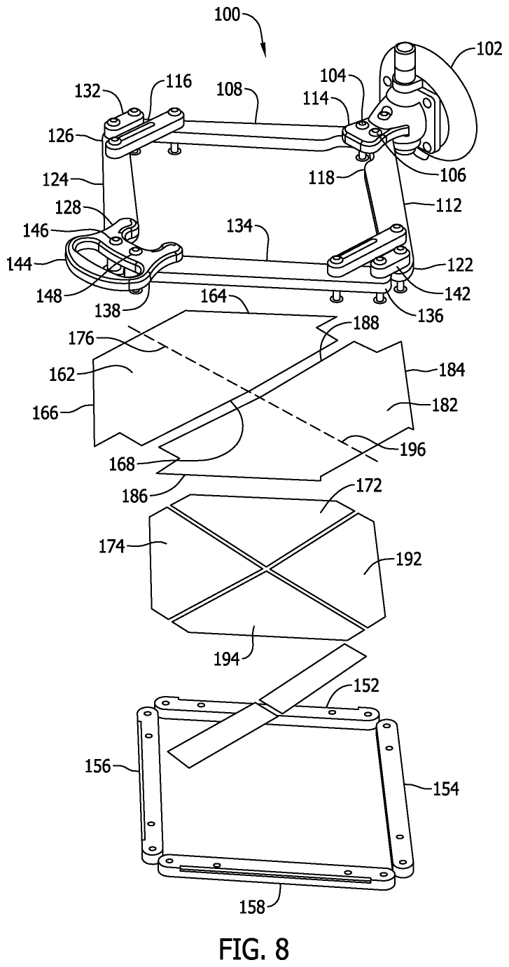

FIG. 8 is a representation of a perspective view of the component parts and the steps involved in assembling the component parts of the collapsible tray supporting apparatus 100 of this disclosure. As in the previously described embodiments, the apparatus 100 of FIG. 8 includes a mount 102 that is constructed and functions in the same manner as the mount 12 described previously.

First 104 and second 106 pivot connections are provided on the mount 102. The pivot connections 104, 106 represented in FIG. 8 are pivot pins that are inserted into mating holes on the mount 102. Other equivalent types of pivot connections could be used.

A first proximal arm 108 and a second proximal arm 112 are connected to the mount 102 by the respective pivot connections 104, 106. The first proximal arm 108 has a straight, rigid length between a first end 114 of the first proximal arm and a second end 116 of the first proximal arm. The first end 114 of the first proximal arm 108 is connected by the pivot connection 104 to the mount 102. The second proximal arm 112 also has a straight, rigid length between a first end 118 of the second proximal arm 112 and a second end 122 of the second proximal arm. The first end 118 of the second proximal arm 112 is connected by the pivot connection 106 to the mount 102.

A first distal arm 124 is connected to the first proximal arm 108. The first distal arm 124 has a rigid, straight length with opposite first 126 and second 128 ends. The first end 126 of the first distal arm 124 is connected to the second end 116 of the first proximal arm 108 by a pivot connection 132. The pivot connection 132 is provided by pivot pins that extend through a pivot connection bar and through aligned pivot holes in the second end 116 of the first proximal arm 108 and the first end 126 of the first distal arm 124.

A second distal arm 134 is connected to the second proximal arm 112. The second distal arm 134 has a rigid, straight length with opposite first 136 and second 138 ends. The first end 136 of the second distal arm 134 is connected to the second end 122 of the second proximal arm 112 by a pivot connection 142. The pivot connection 142 is provided by pivot pins that extend through a pivot connection bar and through aligned pivot holes in the second end 122 of the second proximal arm 112 and the first end 136 of the second distal arm 134.

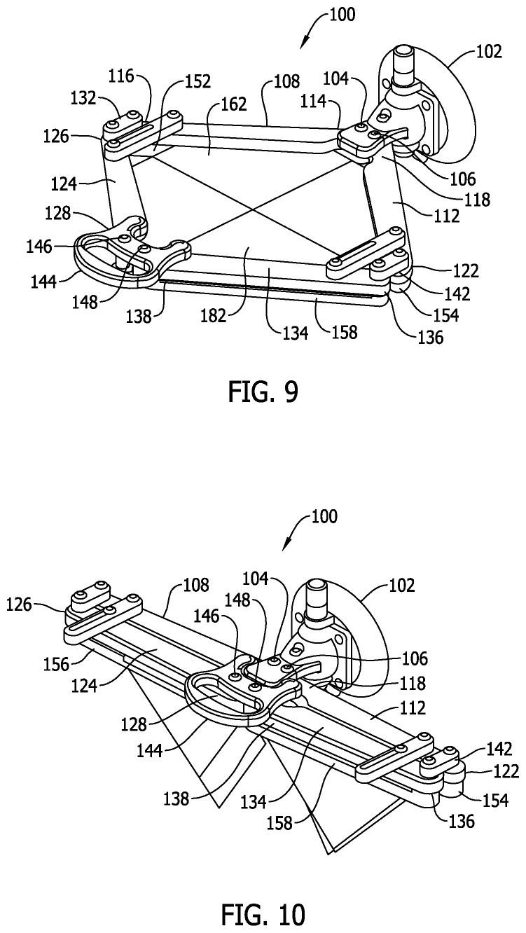

A handle 144 is connected by pivot connections 146, 148 to the second end 128 of the first distal arm 124 and to the second end 138 of the second distal arm 134, respectively. The pivot connections 146, 148 are provided by pivot pins that are inserted through aligned pivot holes in the handle 144 and in the second end 128 of the first distal arm 124 and the second end 138 of the second distal arm 134. The pivot connections enable the handle 144 to be moved toward and into engagement with the mount 102 as represented in FIG. 10 to close the top surface of the tray, and enable the handle 144 to be moved out of engagement with the mount 102 and away from the mount to open the top surface of the tray as represented in FIG. 9.

A first proximal clamp 152 is secured beneath the first proximal arm 108. The first proximal clamp 152 has substantially the same configuration as the first proximal arm 108. The first proximal clamp 152 is secured beneath the first proximal arm 108 by the pivot connection 104 and the pivot connection 132.

A second proximal clamp 154 is secured beneath the second proximal arm 112. The second proximal clamp 154 has substantially the same configuration as the second proximal arm 112. The second proximal clamp 154 is secured beneath the second proximal arm 112 by the pivot connection 106 and the pivot connection 142.

A first distal clamp 156 is secured beneath the first distal arm 124. The first distal clamp 156 has substantially the same configuration as the first distal arm 124. The first distal clamp 156 is secured beneath the first distal arm 124 by the pivot connection 132 and the pivot connection 146.

A second distal clamp 158 is secured beneath the second distal arm 134. The second distal clamp 158 has substantially the same configuration as the second distal arm 134. The second distal clamp 158 is secured beneath the second distal arm 134 by the pivot connection 142 and the pivot connection 148.

A first sheet 162 extends between the first proximal arm 108 and the first distal arm 124 and forms one half of the top surface of the tray of the apparatus 100. The first sheet 162 is constructed of a water resistant fabric or other equivalent type of material. The first sheet 162 has a first proximal edge 164 that is secured between the first proximal arm 108 and the first proximal clamp 152 and an opposite first distal edge 166 that is secured between the first distal arm 124 and the first distal clamp 156. The first sheet 162 also has a first center edge 168 that extends across the sheet from the first proximal edge 164 to the first distal edge 166.

As represented in FIG. 8, a first proximal panel 172 and a first distal panel 174 are secured to the underside of the first sheet 162. The panels 172, 174 are constructed of a rigid material that supports the first sheet 162. As represented in FIG. 8, the panels 172, 174 together conform to the basic peripheral configuration of the first sheet 162 when secured to the underside of the first sheet. A gap between the panels 172, 174 forms a first fold line 176 across the first sheet 162.

A second sheet 182 extends between the second proximal arm 112 and the second distal arm 134 and forms the other half of the top surface of the tray. The second sheet 182, like the first sheet 162 is constructed of a water resistant fabric or other equivalent type of material. The second sheet 182 has a second proximal edge 184 that is secured between the second proximal arm 112 and the second proximal clamp 154 and an opposite second distal edge 186 that is secured between the second distal arm 134 and the second distal clamp 158. The second sheet 182 also has a second center edge 188 that extends across the sheet from the second proximal edge 184 to the second distal edge 186.

A second proximal panel 192 and a second distal panel 194 are secured to the underside of the second sheet 182. The panels 192, 194 are constructed of a rigid material that supports the second sheet 182. As represented in FIG. 8, the panels 192, 194 together conform to the basic peripheral configuration of the second sheet 182 when secured to the underside of the second sheet. A gap between the panels 192, 194 forms a second fold line 196 across the second sheet 182.

As represented in FIG. 9, when the handle 144 is moved away from the mount 102, the first sheet 162 and second sheet 182 are pulled taut and tight between the first proximal arm 108 and second proximal arm 112 and the respective first distal arm 124 and second distal arm 134. Together the taut first sheet 162 and second sheet 182 and the respective first panels 172, 174 and second panels 192, 194 beneath the sheets are positioned in planar orientations and form the firm and stiff top surface of the tray represented in FIG. 9.

When the handle 144 is moved back toward and into engagement with the mount 102 as represented in FIG. 10, the first sheet 162 and the proximal panel 172 and distal panel 174 beneath the first sheet fold at the first fold line 176, and the second sheet 182 and the proximal panel 192 and distal panel 194 beneath the second sheet fold at the second fold line 196 and are positioned in angular orientations and folded to their closed configurations.

As various modifications could be made in the construction of the collapsible bag and/or tray supporting apparatus and its method of operation herein described and illustrated without departing from the scope of this disclosure, it is intended that all matter contained in the foregoing description and shown in the accompanying drawings shall be interpreted as illustrative only rather than limiting. Thus, the breadth and scope of the present disclosure should not be limited by any of the above described or shown examples but should be defined only in accordance with the following claims appended hereto and their equivalents.

1. A collapsible holding device supporting apparatus comprising:
a mount that is attachable to a separate surface;
first and second proximal arms that are connected to the mount;
first and second distal arms that are connected to the respective first and second proximal arms;
a handle that is connected to the first and second distal arms; and
a holding device supported by the first and second proximal arms and the first and second distal arms with the holding device being opened between the first and second proximal arms and the first and second distal arms.

2. The apparatus of claim 1, further comprising:
pivot connections connecting the first and second proximal arms to the mount, pivot connections connecting the first and second distal arms to the respective first and second proximal arms, and pivot connections connecting the handle to the first and second distal arms.

3. The apparatus of claim 2, further comprising:
the pivot connections being adapted and configured to enable the handle to be moved toward the mount and thereby positioning the first and second proximal arms adjacent the respective first and second distal arms and closing the opened holding device, and to enable the handle to be moved away from the mount and thereby positioning the first and second proximal arms at angles relative to the respective first and second distal arms and opening the holding device.

4. The apparatus of claim 3, further comprising:
the handle being attachable to the mount to thereby hold the opening of the holding device closed in response to the handle being moved toward and into engagement with the mount and attaching the handle to the mount; and
the handle being detachable from the mount to thereby open the holding device in response to the handle being detached from the mount and moved out of engagement with and away from the mount.

5. The apparatus of claim 2, further comprising:
the pivot connections orienting the first and second proximal arms and the first and second distal arms in horizontal orientations.

6. The apparatus of claim 1, further comprising:
the holding device being a bag.

7. The apparatus of claim 6, further comprising:
the bag having a top perimeter edge surrounding an opening into the bag;
the bag having at least one tubular sleeve extending along the top perimeter edge of the bag; and
at least one of the first and second proximal arms and the first and second distal arms extending through the at least one tubular sleeve of the bag.

8. The apparatus of claim 1, further comprising:
the holding device being a tray.

9. The apparatus of claim 8, further comprising:
the tray having proximal panels and distal panels that are foldable between angular orientations and planar orientations.

10. A collapsible holding device supporting apparatus comprising:
a mount that is attachable to a separate surface;
first and second proximal arms secured to the mount for movements between aligned positions where the first and second proximal arms are in end-to-end alignment and extend from opposite sides of the mount away from each other, and angled positions where the first and second proximal arms are oriented at an angle and extend outward from the mount;
first and second distal arms secured to the respective first and second proximal arms for movements between adjacent positions where the first and second distal arms are adjacent and alongside the respective first and second proximal arms, and angled positions where the first proximal arm and first distal arm are oriented at an angle and the second proximal arm and second distal arm are oriented at an angle;
a handle secured to the first and second distal arms, the handle being movable toward the mount and away from the mount; and
a holding device supported by the first and second proximal arms and the first and second distal arms, the holding device being movable to a closed configuration in response to the handle being moved toward the mount and the holding device being movable to an opened configuration in response to the handle being moved away from the mount.

11. The apparatus of claim 10, further comprising:
pivot connections connecting the first and second proximal arms to the mount, pivot connections connecting the first and second distal arms to the respective first and second proximal arms, and pivot connections connecting the handle to the first and second distal arms.

12. The apparatus of claim 10, further comprising:
the handle being attachable to the mount to thereby hold the holding device in the closed configuration in response to the handle being moved toward and into engagement with the mount and attaching the handle to the mount; and
the handle being detachable from the mount to thereby move the holding device to the opened configuration in response to the handle being moved out of engagement with and away from the mount.

13. The apparatus of claim 10, further comprising:
the holding device being a bag.

14. The apparatus of claim 13, further comprising:
the bag having a top perimeter edge surrounding an opening into the bag;
the bag having tubular sleeves extending along the top perimeter edge of the bag; and
the first and second proximal arms and the first and second distal arms extending through the tubular sleeves of the bag.

15. The apparatus of claim 10, further comprising:
the holding device being a tray.

16. A collapsible holding device supporting apparatus comprising:
a mount, the mount having opposite first and second surfaces;
an attachment device on the first surface of the mount, the attachment device being releasably attachable to a separate surface, the attachment device comprising a vacuum suction actuator;
first and second pivot connections on the second surface of the mount;
a first proximal arm having a length with opposite first and second ends, the first end of the first proximal arm being connected to the second surface of the mount by a pivot connection, the second end of the first proximal arm having a pivot connection on the second end of the first proximal arm;
a second proximal arm having a length with opposite first and second ends, the first end of the second proximal arm being connected to the second surface of the mount by a pivot connection, the second end of the second proximal arm having a pivot connection on the second end of the second proximal arm;
a first distal arm having a length with opposite first and second ends, the first end of the first distal arm being connected to the second end of the first proximal arm by the pivot connection on the second end of the first proximal arm, the distal end of the first distal arm having a pivot connection on the second end of the first distal arm;
a second proximal arm having a length with opposite first and second ends, the first end of the second distal arm being connected to the second end of the second proximal arm by the pivot connection on the second end of the second proximal arm, the second end of the second distal arm having a pivot connection on the second end of the second distal arm;
a handle, the handle being connected to the second end of the first distal arm by the pivot connection on the second end of the first distal arm, the handle being connected to the distal end of the second distal arm by the pivot connection on the second end of the second distal arm, the handle being releasably attachable to the second surface of the mount; and
a holding device supported on the first proximal arm, the second proximal arm, the first distal arm and the second distal arm.

17. The apparatus of claim 16, further comprising:
the first and second proximal arms, the first and second distal arms, and the handle being connected in horizontal orientations.

18. The apparatus of claim 16, further comprising:
the holding device being a bag having a top opening, the top opening of the bag being closed by the handle being releasably attached to the second surface of the mount which causes the first proximal arm to be positioned adjacent the first distal arm and causes the second proximal arm to be positioned adjacent the second distal arm; and
the top opening of the bag being opened by the handle being detached from the second surface of the mount which causes the first proximal arm to separate from the first distal arm and causes the second proximal arm to separate from the

19. The apparatus of claim 18, further comprising:
the bag having a top perimeter edge surrounding the top opening into the bag;
the bag having tubular sleeves extending along the top perimeter edge of the bag; and
the first and second proximal arms and the first and second distal arms extending through the tubular sleeves of the bag.

20. The apparatus of claim 16, further comprising:
the holding device being a tray.
